(19) United States
(12) Patent Application Publication
(10) Pub. No.: US 2004/0031189 A1
(43) Pub. Date: Feb. 19, 2004

(54) Rodent bait delivery system

(76) Inventor: Derek F. Brown, Stone Mountain, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/222,514

(22) Filed: Aug. 16, 2002

(51) Int. Cl. A01M 1/20; A01M 25/00

(52) U.S. Cl. 43/131

(57) ABSTRACT

A tamper resistant bait delivery system that uses visual and olfactory stimuli to attract rodents, and that allows rodents to access poison bait without fully entering the system's outer housing. The bait system is comprised of: (1) an outer housing that defines an interior portion and one or more access windows; and (2) a bait module is disposed within the interior portion. The bait module preferably comprises a poison portion, an olfactory attractor portion, and a visual attractor portion. The system is preferably configured to allow a rodent to see and smell the bait module through the access windows within the system's outer housing. This entices the rodent to extend its head through the access windows and consume the poison portion of the bait module. Preferably, the bait module's visual attractor portion is a reflective surface that visually attracts rodents by reflecting light out of the access windows.

### FIELD OF THE INVENTION

This invention relates generally to tamper resistant rodent bait delivery systems, and particularly relates to bait delivery systems that use poisonous bait to attract and kill rodents.

### BACKGROUND OF THE INVENTION

Keeping rodent populations controlled outside a house or a building prevents the rodents from becoming a problem inside. Several different types of rodent control devices can be used to prevent the entry of rodents into a house or building. These devices include, for example, traps, glue boards, and bait delivery systems. Traps and glue boards are undesirable because they require users to clean up any captured dead rodents. Bait delivery systems are advantageous because they do not require a user to clean up dead rodents, but instead, allow rodents to feed on poisonous bait and then travel to another location to die.

With most current rodent bait delivery systems, the poison bait is enclosed in a tamper resistant housing. Usually, such housings are made of heavy, industrial, black plastic and are big enough to allow rodents to walk around inside the housings. The bait is typically hidden behind a maze-like structure of interior walls within the housing to keep children and pets from reaching and ingesting the bait. Because the bait is hidden within this internal structure, the rodents must fully enter the housing to eat the bait.

Early rodent bait systems included a housing having two holes through which rodents could enter or exit the device. However, the housings of more recent prior art bait delivery systems, such as the system taught in U.S. Pat. No. 6,082,042, have three or more holes through which the rodents can enter or exit the device. These additional holes were added because research indicated that rodents felt vulnerable to an attack by other rodents in the two-holed housings and, thus, were less likely to eat the bait without at least one escape route.

Although the housings of prior art systems prevent children and household animals from accessing the bait, the housings also prevent rodents from smelling or seeing the bait from a distance. This is due, at least in part, to the fact that the distance that the bait's smell can travel is limited by the bait's enclosure in the housing and the size and complexity of the housing that encloses the bait. Additionally, rodents are not visually attracted to the housing or the bait because the housing is black and the bait is not visible from outside the housing. As a result, rodents may overlook the housing and bait and search for food elsewhere, such as within a nearby house or building. This may result in an undesirable infestation of the house or building.

Therefore, there is a need in the art for a bait delivery system that is tamper resistant like prior art systems, but that is configured to attract more rodents more effectively than prior art systems.

### SUMMARY OF THE INVENTION

The present invention seeks to provide a tamper resistant bait delivery system that attracts rodents to bait within the delivery system more effectively than prior art systems. More particularly, the invention is configured to: (1) increase the distance from which rodents can smell the bait; (2) visually attract rodents; and (3) provide access to the bait without forcing rodents to enter the housing fully to retrieve the bait.

A rodent bait delivery system according to a preferred embodiment of the invention comprises an outer housing defining both an interior portion and one or more access windows, and a bait module disposed within the interior portion. The outer housing and the bait module are preferably configured to allow a rodent to see the bait module through one or more of the access windows.

In a preferred embodiment of the invention, the outer housing is configured to be moved from an unlocked configuration, in which access to the interior portion of the outer housing is substantially unrestricted, to a locked configuration in which access to the interior portion is substantially restricted. In this embodiment, the outer housing is preferably configured to allow access to the interior portion only through the plurality of access windows when the outer housing is in the locked configuration. Each access window is preferably dimensioned to allow a rodent to extend its head through the access window but to prevent removal of the bait module through the access window.

In a preferred embodiment of the invention, the bait module comprises a poison portion, an olfactory attractor portion disposed adjacent the poison portion, and a visual attractor portion disposed adjacent the olfactory attractor portion. In this preferred embodiment, the olfactory attractor portion comprises rodent food, and the visual attractor portion comprises a reflective material.

In a further preferred embodiment of the invention, the visual attractor portion is configured to reflect light at a plurality of angles through the one or more access windows. In this embodiment, the olfactory attractor portion is preferably disposed between the poison portion and the visual attractor portion, and the visual attractor portion is sufficiently thin to allow a rodent to nibble through it. The visual attractor portion and the olfactory attractor portion may be configured to allow a rodent to access the olfactory attractor portion by nibbling through the visual attractor portion.

Yet another embodiment of the invention comprises: (1) an outer housing defining both an interior portion and one or more access windows; (2) one or more poison portions disposed within the interior portion; and (3) one or more visual attractor portions disposed adjacent the poison portion.

A method of delivering a poison portion to a rodent according to the present invention comprises the steps of: (1) providing an outer housing that defines both an interior portion and one or more access windows; (2) positioning the poison portion within the interior portion of the housing; and (3) enticing a rodent to consume at least part of the poison portion by positioning a visual attractor portion within the interior portion of the housing so the visual attractor portion reflects light through the one or more access windows at a plurality of angles.

### BRIEF DESCRIPTION OF THE DRAWINGS

FIG. 1 is a top view of a preferred embodiment of the rodent bait delivery system.

FIG. 2 is a top view of an alternative embodiment of the rodent bait delivery system.

FIG. 3 is a sectional view of the rodent bait delivery system according to the embodiment of FIG. 1 taken substantially along Line 1-1 of FIG. 1 in the direction indicated by the arrows of Line 1-1.

FIG. 4 is a sectional view of the rodent bait delivery system according to the alternative embodiment of FIG. 2 taken substantially along Line 2-2 of FIG. 2 in the direction indicated by the arrows of Line 2-2.

FIG. 5 is a sectional view of a bait module according to a preferred embodiment of the invention taken substantially along Line 3-3 of FIGS. 3 and 4 in the direction indicated by the arrows of Line 3-3.

FIG. 6 is a sectional view of a bait module according to an alternative embodiment of the invention taken substantially along Line 3-3 of FIGS. 3 and 4 in the direction indicated by the arrows of Line 3-3.

FIG. 7 is a sectional view of a bait module according to another alternative embodiment of the invention taken substantially along Line 3-3 of FIGS. 3 and 4 in the direction indicated by the arrows of Line 3-3.

FIG. 8 is a sectional view of a bait module according to yet another alternative embodiment of the invention taken substantially along Line 3-3 of FIGS. 3 and 4 in the direction indicated by the arrows of Line 3-3.

FIG. 9 is a sectional view of a bait module according to still another alternative embodiment of the invention taken substantially along Line 3-3 of FIGS. 3 and 4 in the direction indicated by the arrows of Line 3-3.

### DETAILED DESCRIPTION OF THE INVENTION

The present invention will now be described more fully hereinafter with reference to the accompanying drawings, in which embodiments of the invention are shown. The invention may, however, be embodied in many different forms and should not be construed as limited to the embodiments set forth herein. Rather, these embodiments are provided so this disclosure will be thorough and complete and will fully convey the scope of the invention to those skilled in the art. Like numbers refer to like elements throughout.

Overview

A preferred embodiment of the invention comprises a hollow outer housing and a bait module that is disposed within an interior portion of the outer housing. The outer housing preferably includes a locking mechanism for restricting access to the bait module. The outer housing, locking mechanism, and bait module are discussed in greater detail below.

Outer Housing

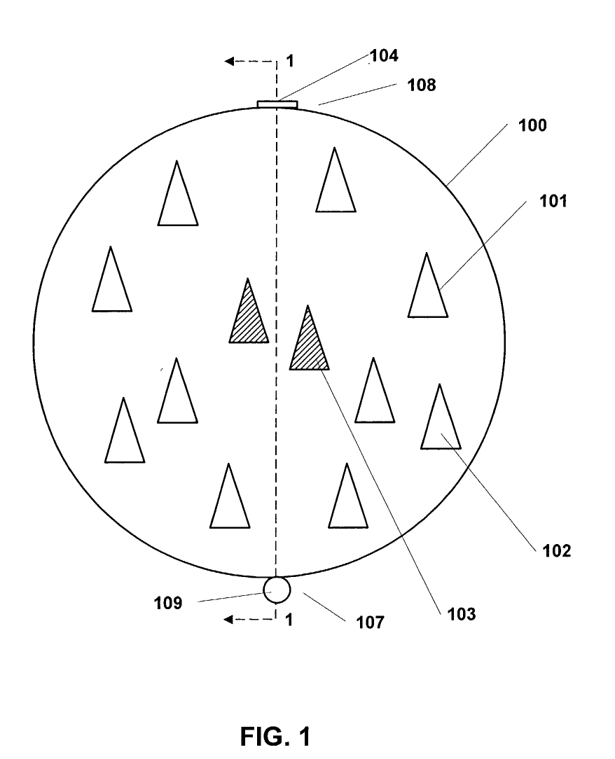

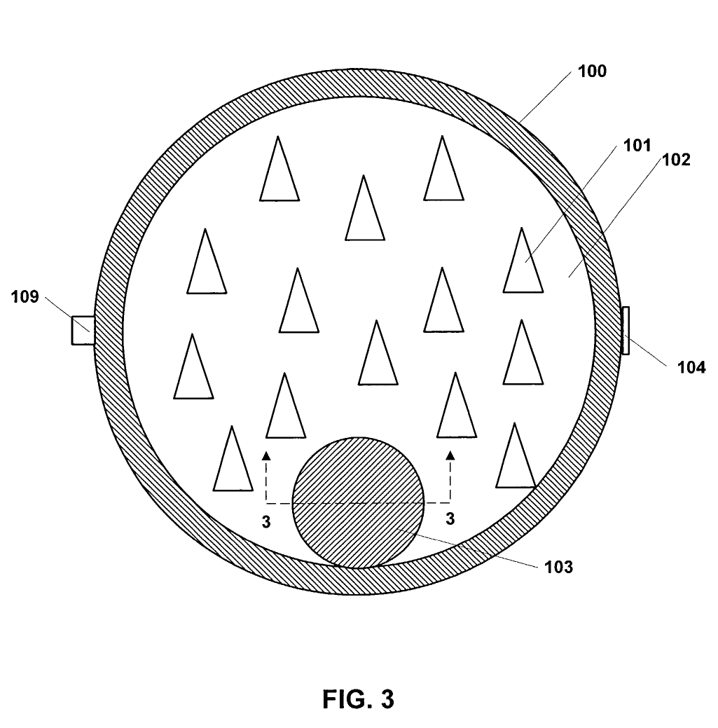

Referring to the accompanying drawings, FIGS. 1 and 3 illustrate a rodent bait delivery system according to a preferred embodiment of the invention. As shown in these figures, in this embodiment of the invention, the outer housing 100 is a hollow spherical housing that defines both a plurality of access windows 101 and an interior portion 102. The access windows 101 are preferably dimensioned to allow a rodent to see and access the bait module 103 through at least one of the access windows 101, but so that the bait module 103 cannot be removed through any of the access windows 101. The outer diameter of the outer housing 100 is preferably between about 4 and 8 inches. The access windows 101 are preferably triangular with a base width of between about 0.75 and 1.5 inches and a height of between about 0.5 and 1.5 inches.

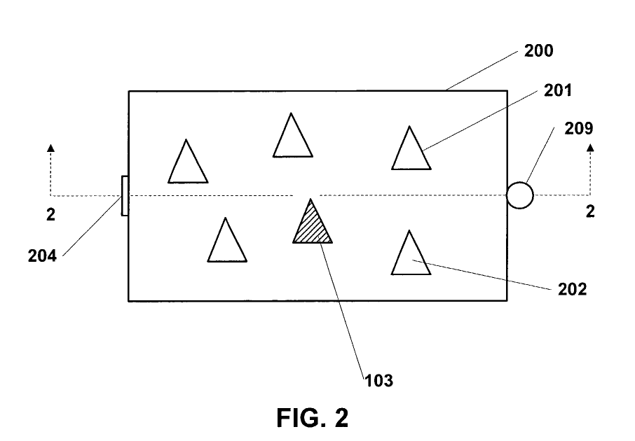

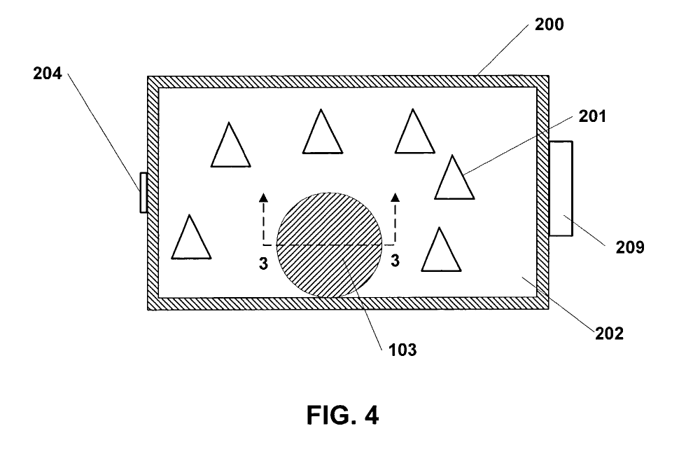

FIGS. 2 and 4 illustrate an alternative embodiment of the rodent bait delivery system that is substantially similar to the preferred embodiment described above. As may be understood from these figures, the outer housing 200 is a hollow rectangular box and defines both a plurality of access windows 201 and an interior portion 202. The access windows 201 are preferably about the same size and shape as the access windows 101 in the preferred embodiment of the invention described above. As will be understood by one skilled in the art, this embodiment functions in generally the same way as the embodiment of the invention described above. However, the rectangular shape of the box is advantageous because it prevents the housing from rolling out of a desired position.

As will be understood by one skilled in the art, the outer housing 100, 200 may be any of a variety of shapes and sizes. For example, the outer housing 100, 200 may be generally spherical, box-shaped, conical, polyhedral, cylindrical, or elliptical.

Similarly, as will be understood by one skilled in the art, while the access windows 101, 201 are described above as triangles, the access windows 101, 201 may be any of a variety of other shapes and sizes. For example, the access windows 101, 201 may be circular, rectangular, elliptical, or polygonal. Additionally, the various access windows 101, 201 on any particular housing may be a variety of different shapes.

Locking Mechanism

In a preferred embodiment of the invention illustrated in FIGS. 1 and 3, the outer housing 100 is preferably configured to be moved from an unlocked configuration, in which access to the interior portion 102 of the outer housing 100 is substantially unrestricted, to a locked configuration in which the interior portion 102 is only accessible through the access windows 101. The outer housing 100 is preferably secured in the locked configuration by a locking mechanism 104.

As shown in FIGS. 1 and 3, the outer housing 100 preferably comprises two substantially identical, hemispherical halves, each of which comprises a substantially circular outer rim. As discussed in greater detail below, these two halves are configured to rotate relative to each other when moved from a locked to an unlocked configuration.

In a preferred embodiment of the invention, the outer housing 100 includes a hinged side 107 and a locking side 108 opposite the hinged side 107 (See FIG. 1). In this embodiment of the invention, a hinge 109 is disposed on the hinged side 107 of the housing 100 along Line 1-1, which is shown in FIG. 1. Similarly, a locking mechanism 104 is disposed on the locking side 108 of the housing 100 along Line 1-1. The hinge 109 is configured to allow the two halves to rotate, about an axis defined by the hinge 109, between a closed and open configuration.

In the closed configuration, the circular outer rims of the respective halves are disposed immediately adjacent each other and the halves define a hollow sphere. In the open configuration, there is a gap between the halves so that a user can access the interior portion 102 of the halves through the gap, and the two halves are separated and connected by the hinge 109.

The locking mechanism 104 is preferably configured to prevent the housing 100 from being moved from the closed configuration to the open configuration when the locking mechanism 104 is engaged. When the housing 100 is in a locked configuration, the housing 100 is in the closed configuration and the locking mechanism 104 is engaged. In this locked configuration, the two halves of the housing 100 are substantially restricted from moving relative to each other. Thus, when the housing 100 is in the locked configuration, access to the interior portion 102 of the housing 100 is substantially restricted.

Similarly, when the housing 100 is in an unlocked configuration, the housing 100 is either in the open configuration or the closed configuration, but the locking mechanism 104 is not engaged. Thus, in the unlocked configuration the two halves of the housing 100 are preferably free to rotate relative to each other about the hinge 109. Accordingly, when the housing 100 is in the unlocked configuration, access to the interior portion 102 of the housing 100 is substantially unrestricted.

As will be understood by one skilled in the art, the locking mechanism 104 may include any known lock device. For example, the locking mechanism 104 may include a combination lock, a snap lock, or two hooks and a padlock. In one particular embodiment of the invention, the locking mechanism 104 is a threaded fastener that extends around the circumference of the outer housing 100 substantially along the 1-1 Line shown in FIG. 1. This embodiment of a locking mechanism 104 preferably includes a child-safety thread configuration that is configured to require a user to perform a somewhat complex physical task to move the housing 100 from a locked to an unlocked position. For example, in one embodiment of the invention, the locking mechanism 104 is configured to only move from a locked to an unlocked position in response to a user pushing one half of the housing 100 towards the other half while rotating the halves relative to each other. In a preferred embodiment of the invention, this locking mechanism 104 is similar to the thread configuration used on child-safety caps for medicine bottles. As will be understood by one skilled in the art, this embodiment of the invention preferably does not include a hinge 109.

Bait Module

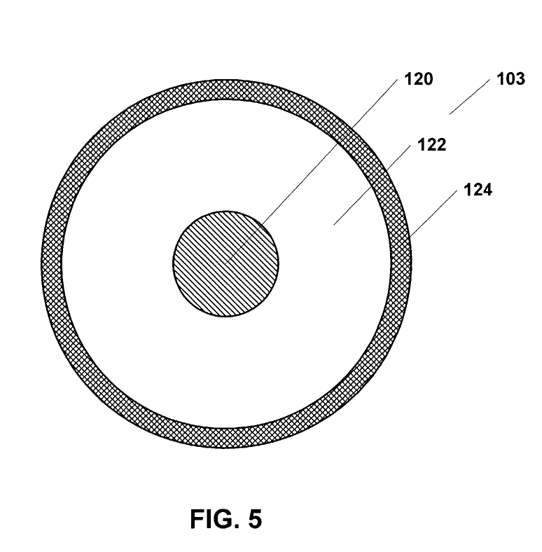

A preferred embodiment of the bait module 103 is shown in FIG. 5. This embodiment of the bait module 103 comprises a poison portion 120, an olfactory attractor portion 122 disposed adjacent the poison portion 120, and a visual attractor portion 124 disposed adjacent the olfactory attractor portion 122. The poison portion 120 may be any poisonous substance, but is preferably a standard rodent bait, such as Contrac Blox®. The olfactory attractor portion 122 is any substance that will attract a rodent by smell. The olfactory attractor portion 122 preferably comprises food, such as peanut butter, but may comprise other substances such as a chemical that gives off an odor that attracts rodents.

The visual attractor portion 124 is a device or material that is configured to direct concentrated light. For example, the visual attractor portion 124 may be a material that reflects concentrated light at a plurality of angles (such as aluminum foil), or battery-powered light source. In a preferred embodiment of the invention, the visual attractor portion 124 is aluminum foil.

In a preferred embodiment of the invention, the visual attractor portion 124 is entirely surrounded by the olfactory attractor portion 122. In this embodiment of the invention, the olfactory attractor portion 122 is preferably entirely surrounded by the visual attractor portion 124.

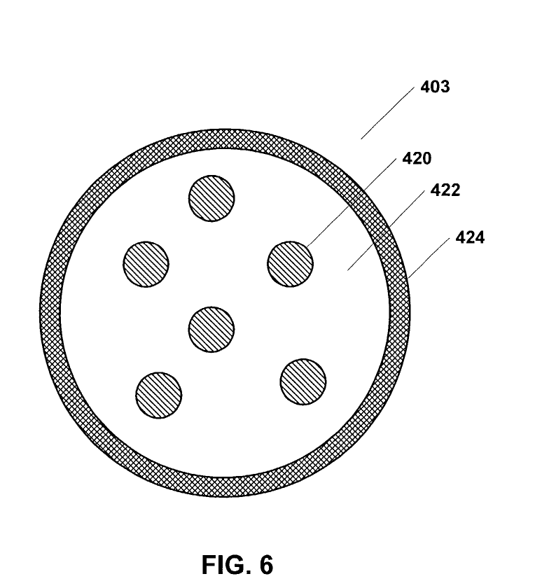

An alternative embodiment of the bait module 403 is shown in FIG. 6. As shown in this figure, this bait module 403 comprises a poison portion 420, an olfactory attractor portion 422 disposed adjacent the poison portion 420, and a visual attractor portion 424 disposed adjacent both the poison portion 420 and the olfactory attractor portion 422. The poison portion 420 in this particular embodiment is mixed with the olfactory attractor portion 422 and preferably formed into a spherical shape. The visual attractor portion 424 preferably surrounds the mixture of poison portion 420 and olfactory attractor portion 422. In this embodiment, the poison portion 420 and olfactory attractor portion 422 may be mixed in many different ways. For example, the poison portion 420 and olfactory attractor portion 422 may be mixed uniformly, or so that high concentrations of the poison portion 420 and/or olfactory attractor portion 422 are on the outer surface of the bait module 403.

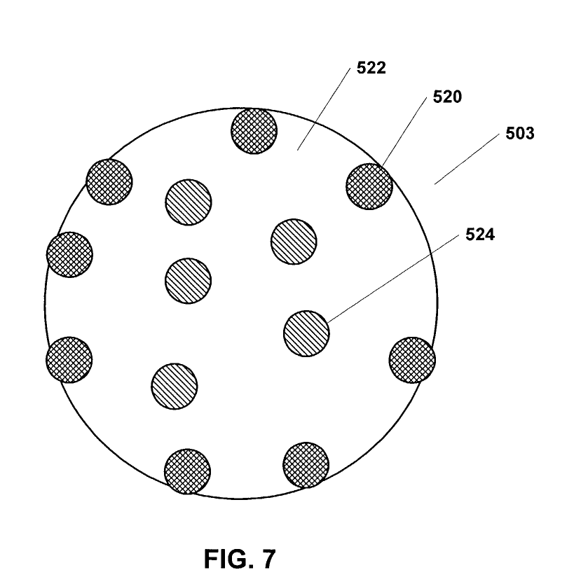

Another alternative embodiment of the bait module 503 is shown in FIG. 7. As may be understood from this figure, this bait module 503 comprises a poison portion 520, an olfactory attractor portion 522 disposed adjacent the poison portion 520, and a visual attractor portion 524 disposed adjacent the poison portion 520 and the olfactory attractor portion 522. The poison portion 520 in this embodiment is mixed with both the olfactory attractor portion 522 and the visual attractor portion 524 and the mixture is preferably formed into a spherical shape. The poison portion 520, olfactory attractor portion 522, and visual attractor portion 524 may be mixed in many different ways. For example, the poison portion 520, olfactory attractor portion 522, and visual attractor portion 524 may be mixed uniformly, or so that high concentrations of the poison portion 520, olfactory attractor portion 522, and/or visual attractor portion 524 are on the outer surface of the bait module 503. In this embodiment, the visual attractor portion 524 is preferably visible from the exterior of the bait module 503.

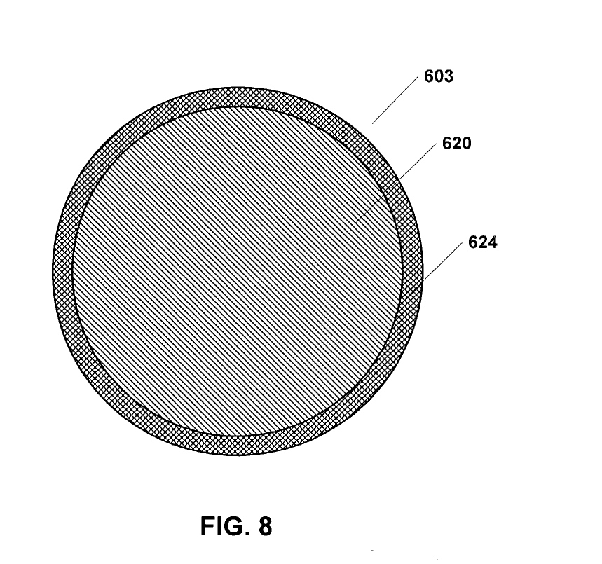

Another alternative embodiment of the bait module 603 is shown in FIG. 8. As may be understood from this figure, this bait module 603 comprises a poison portion 620 and a visual attractor portion 624 that is disposed adjacent the poison portion 620. The poison portion 620 in this embodiment is preferably entirely surrounded by the visual attractor portion 624, and the resulting bait module 603 is preferably spherical.

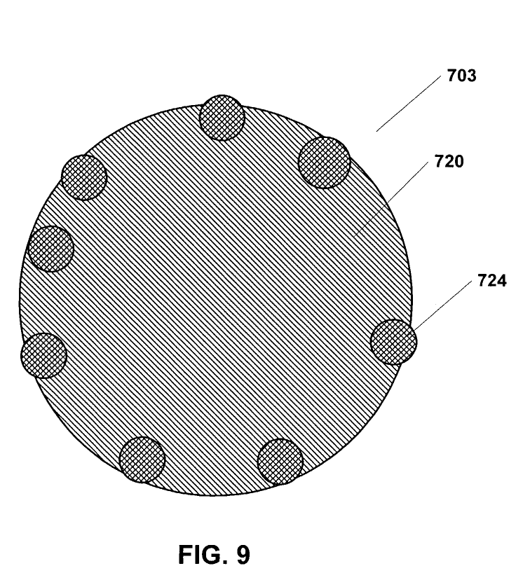

Another alternative embodiment of the bait module 703 is shown in FIG. 9. As shown in this figure, in this embodiment of the invention, the bait module 703 comprises a poison portion 720 that is disposed adjacent a visual attractor portion 724. The poison portion 720 and visual attractor portion 724 preferably form a sphere. In this embodiment, the poison portion 720 and visual attractor portion 724 may be mixed in many different ways. For example, the poison portion 720 and visual attractor portion 724 may be mixed uniformly, or so that high concentrations of the poison portion 720 or visual attractor portion 724 are on the outer surface of the bait module 703.

In the various embodiments of the bait module 103, 403, 503, 603, 703 described above and illustrated by FIGS. 5 through 9, the bait module 103, 403, 503, 603, 703 is preferably spherical, and the diameter of the bait module 103, 403, 503, 603, 703 is preferably between about 1 and 1.75 inches. While the bait module 103, 403, 503, 603, 703 is preferably spherical, as will be understood by one skilled in the art, the bait module 103, 403, 503, 603, 703 may be any of a variety of shapes and sizes. For example, the bait module 103, 403, 503, 603, 703 may be spherical, box-shaped, cylindrical, polyhedral, or elliptical.

In some situations, such as in an industrial or commercial setting or in homes where the risk of children or pets accidentally coming into contact with the bait module 103, 403, 503, 603, 703 is insignificant, the tamper resistant characteristic provided by the outer housing 100, 200 of the rodent bait delivery 'system described in FIGS. 1 through 4 is not necessary. In such situations, the bait module 103, 403, 503, 603, 703 may be deployed without an outer housing 100, 200.

Use of the Rodent Bait Delivery System

A method of delivering bait (such as a poison portion 320, 420, 520, 620, 720) to a rodent, according to a preferred embodiment of the invention, comprises the steps of: (1) providing an outer housing 100, 200 that defines both an interior portion 102, 202 and one or more access windows 101, 201; (2) positioning the poison portion 320, 420, 520, 620, 720 within the interior portion 102, 202 of the outer housing 100, 200; and (3) enticing a rodent to consume at least part of the poison portion 320, 420, 520, 620, 720 by positioning the visual attractor portion 124, 424, 524, 624, 724 in the interior portion 102, 202 of the outer housing 100, 200 so that the visual attractor portion 124, 424, 524, 624, 724 reflects light through the one or more access windows 101, 201 at a plurality of angles.

In one embodiment of the invention, the outer housing 100, 200 and bait module 103, 403, 503, 603, 703 are manufactured and packaged so that the bait module 103, 403, 503, 603, 703 is disposed within the outer housing 100, 200 and so that the outer housing 100, 200 may not be moved out of the unlocked configuration. This is advantageous because it alleviates the need for the user to touch the bait module 103, 403, 503, 603, 703 before using the bait delivery system.

Alternatively, the rodent bait delivery system may be manufactured and packaged in the form of a kit. To use such a system, the user first moves the outer housing 100, 200 into the unlocked and open configuration and inserts the bait module 103, 403, 503, 603, 703 into the interior portion 102, 202 of the bait module 103, 403, 503, 603, 703. The user then moves the outer housing 100, 200 into the closed and locked configuration so that the bait module 103 is locked into the interior of the bait module 103, 403, 503, 603, 703.

Once the bait module 103, 403, 503, 603, 703 is secured within the outer housing 100, 200, the user positions the completed system near a likely rodent travel path. The user may then tether the outer housing 100, 200 to a bush or stake to prevent the housing from being moved out of place.

When light shines through the access windows 101, 201 (for example when floodlights, streetlights or headlights from a passing car shine on the outer housing 100, 200), the light reflects off of the visual attractor portion 124, 424, 524, 624, 724 and through the access windows 101, 201. Passing rodents then see the light reflecting off of the bait module's 103, 403, 503, 603, 703 visual attractor portion 124, 424, 524, 624, 724 through the access windows 101, 201. This reflection, combined with the smell of the bait module's 103, 403, 503, 603, 703 olfactory attractor portion 122, 422, 522, 622, 722, attracts the rodents to the system. The rodents then walk to the rodent bait delivery system and begin to nibble at the bait module 103, 403, 503, 603, 703 through the access windows 101, 201. During this process, the rodents consume enough of the poison portion 120, 420, 520, 620, 720 to cause the rodent to die.

Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A rodent bait system comprising:
an outer housing defining both an interior portion and one or more access windows; and
a bait module disposed within said interior portion, said bait module comprising:
(a) a poison portion;
(b) an olfactory attractor portion disposed adjacent said poison portion; and
(c) a visual attractor portion disposed adjacent said olfactory attractor portion;
and wherein said outer housing and said bait module are configured so that a rodent can see said bait module through said one or more access windows.

2. The rodent bait system of claim 1, wherein said olfactory attractor portion comprises rodent food.

3. The rodent bait system of claim 2, wherein said olfactory attractor portion comprises peanut butter.

4. The rodent bait system of claim 1, wherein said visual attractor portion comprises a reflective material.

5. The rodent bait system of claim 4, wherein said visual attractor portion comprises metallic foil.

6. The rodent bait system of claim 1, wherein said outer housing is configured to be moved from an unlocked configuration, in which access to said interior portion of said outer housing is substantially unrestricted, to a locked configuration in which access to said interior portion is substantially restricted.

7. The rodent bait system of claim 6, wherein said outer housing is configured so that, when said outer housing is in said locked configuration, said interior portion may only be accessed through said access windows.

8. The rodent bait system of claim 1, wherein each particular one of said access windows is dimensioned: (1) to allow a rodent to extend its head through said particular access window; and (2) to prevent removal of said bait module through said particular access window.

9. The rodent bait system of claim 8, wherein each particular one of said access windows is dimensioned to prevent removal of said poison portion through said access window.

10. The rodent bait system of claim 1, wherein said visual attractor portion is configured to reflect light at a plurality of angles through said one or more access windows.

11. The rodent bait system of claim 1, wherein at least a portion of said olfactory attractor portion is disposed between said poison portion and said visual attractor portion.

12. The rodent bait system of claim 1, wherein said visual attractor portion is sufficiently thin to allow a rodent to nibble through said visual attractor portion.

13. The rodent bait system of claim 1, wherein said visual attractor portion and said olfactory attractor portion are configured to allow a rodent to access said olfactory attractor portion by nibbling through said visual attractor portion.

14. The rodent bait system of claim 1, wherein said outer housing comprises a plurality of access windows.

15. A rodent bait system comprising:
an outer housing defining both an interior portion and one or more access windows;
one or more pieces of bait disposed within said interior portion; and
one or more pieces of reflective material disposed adjacent said bait, said one or more pieces of reflective material being configured for visually attracting rodents from outside of said outer housing to said pieces of bait.

16. The rodent bait system of claim 15, wherein said reflective material is configured to reflect light at a plurality of angles through said one or more access windows.

17. The rodent bait system of claim 15, wherein said reflective material is disposed adjacent an exterior surface of said bait.

18. The rodent bait system of claim 15, wherein said reflective material is sufficiently thin to allow a rodent to nibble through said reflective material to reach said bait.

19. The rodent bait system of claim 15, wherein said outer housing is configured to be moved from an unlocked configuration, in which access to said interior portion of said outer housing is substantially unrestricted, to a locked configuration in which said interior portion may only be accessed through said access windows.

20. A method of delivering bait to a rodent, said method comprising the steps of:
providing an outer housing that defines both an interior portion and one or more access windows;
positioning rodent bait within said interior portion of said housing; and
enticing a rodent to consume at least a portion of said bait by positioning a reflective material within said interior portion of said housing so that said reflective material reflects light through said one or more access windows at a plurality of angles.
